(19) United States
(12) Patent Application Publication
(10) Pub. No.: US 2011/0313901 A1
(43) Pub. Date: Dec. 22, 2011

(54) REFUND SYSTEM AND METHOD

(76) Inventor: Viktor Kletzer, Wien (AT)

(21) Appl. No.: 13/254,257

(22) PCT Filed: Mar. 3, 2010
(86) PCT No.: PCT/EP2010/052712

§ 371 Date: Sep. 1, 2011

(30) Foreign Application Priority Data
Mar. 4, 2009 (GB) 0903752.4

(51) Int. Cl. G06Q 40/00

(52) U.S. Cl. 705/31

(57) ABSTRACT

In response to receipt of an identifier for at least one of a user or a purchase transaction, a validation system prompts a user to input information for obtaining a tax refund associated with one or more purchase transactions. The validation system causes information relating to users and purchase transactions and stored in a storage system to be updated based on information input by the user. The validation system transmits a validation request message that identifies the user to an approval system that has access to the storage system to validate a tax refund for the one or more purchases for an eligible user, eligibility being derived from user related information. The validation system receives a response message from the approval system and indicates to the user whether a refund associated with the one or more purchases has been validated.

### BACKGROUND

The present invention relates to apparatus, systems and methods for obtaining tax refunds associated with purchases.

Tax refund systems are offered in many countries for travellers. Providing tax free shopping can be attractive to visitors to a country and can help to promote tourism. However, traditionally, the administration for tax free shopping schemes has been paper-based with merchants issuing vouchers or cheques at a point of sale, and then customs verifying the export of the goods at a border. Although regulations vary from country to country, the traditional format for providing tax free shopping is for a merchant in a country to identify and verify that a customer is a visiting traveller entitled to a tax refund, and then to issue the voucher that includes details of the traveller and the purchased item and then for custom to verify at the point of exit from the country that an item being exported and the traveller correspond to the item and traveller identified on the voucher. The refund can then be made. Tax refund operators act with merchants and customs to facilitate the operation of this process and to manage the paperwork associated therewith.

However, such a process is very labour and cost intensive. However, there are significant technical difficulties in ensuring that a tax refund system can operate efficiently, while at the same time being secure.

The present invention seeks to provide a technological solution to such problems.

### SUMMARY

Aspects of the invention are defined in the claims.

An aspect of the invention provides an apparatus comprising a validation system. Validation system input means is configured to receive an identifier for at least one of a user or a purchase transaction. Validation system processing means is configured to prompt the user to input information for obtaining a tax refund associated with one or more purchase transactions. The validation system processing means is further configured to cause information relating to users and purchase transactions and stored in a storage system to be updated based on information input by the user. The validation system processing means is further configured to transmit a validation request message that identifies the user to validate a tax refund for the one or more purchases for an eligible user, eligibility being derived from user related information. The validation system processing means is further operable to receive a response message from the approval system and to indicate via validation system output means to the user whether a refund associated with one or more of the purchases has been validated.

A computer implemented method of processing a refund at a validation system, comprises: validation system input means receiving an identifier for at least one of a user or a purchase transaction; validation system processing means prompting the user to input information for obtaining a tax refund associated with one or more purchase transactions; validation system processing means causing information relating to users and purchase transactions and stored in a storage system to be updated based on information input by the user; the validation system processing means transmitting a validation request message that identifies the user to validate a tax refund for the one or more purchases for an eligible user, eligibility being derived from user related information; and the validation system processing means receiving a response message from the approval system and to indicate to the user via a validation system output means whether a refund associated with one or more of the purchases has been validated.

Although various aspects of the invention are set out in the accompanying claims, other aspects of the invention include any combination of features from the described embodiments and/or the accompanying dependent claims with the features of the independent claims, and not solely the combinations explicitly set out in the accompanying claims.

### BRIEF DESCRIPTION OF THE DRAWINGS

Embodiments are described, by way of example only, with reference to the accompany drawings.

FIG. 1 is a schematic diagram of an example embodiment of a refund system according to an embodiment of the invention;

FIG. 2 is a schematic system overview;

FIGS. 3-7 form flow diagrams of an example method of operation.

### DETAILED DESCRIPTION

An example embodiment of the invention seeks to provide simplicity of operation while providing flexibility of use. In the example embodiment one or more systems coordinate processing of purchases and refunds using one or more tokens that uniquely identify a user, for example a traveller. The one or more systems can be operated by a Tax Refund Operator (TRO).

As well as providing administration of the refund operations, the TRO can provide education for a user and merchants throughout the process. Through the use of information technology systems, the TRO can ensure the integrity of the system.

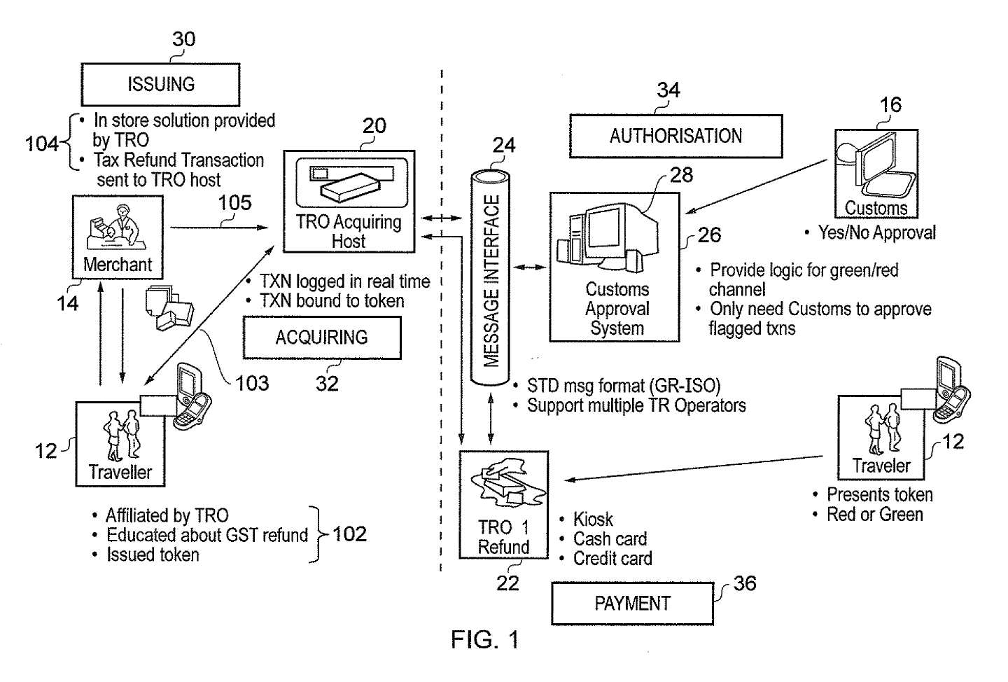

FIG. 1 illustrates an example method, apparatus and system for managing a refund process. In the example process shopping and receiving of a receipt (issuing 30) is separated from further processing (acquiring 32, authorisation 34 and payment 36).

As with credit and debit cards, there can be multiple providers of issuing services, and multiple acquirers of transactions and processing. For example there can be multiple TROs. A wide range of point of sale (POS) devices and in-store support for user shopping can be provided.

In an example embodiment, a merchant system provides the issuing 30 of transactions using TRO provided POS devices and/or software, a TRO host system carries out the acquiring 32, a customs approval system carries out the authorization 34 and a TRO host system carries out the refund payment 36. An automated kiosk (validation system) at a point of exit from a territory can be used for registration and for an approval request. The refund payment can be handled by a refund desk (run by the TRO) for immediate refunds in cash or via information captured earlier in the process for non-cash refunds using back-office processes by the TRO. Alternatively, or in addition, the kiosks could be configured to provide refund payments. Typically, a determination of eligibility will be made in store at a time or purchase. However, subject to legal requirements in a given territory, the determination of eligibility and identity can be moved away from a point of sale to the point of exit from the territory. An example embodiment can provide simplicity and flexibility of use as perceived by the users of the system, while also providing security and integrity of operation.

In a conventional approach, shop assistants and counter cashiers are expected to be able to verify eligibility for a tax refund by examining the passport of the user. In fact, many users are reluctant to carry their passports while out shopping, and so some shops permit the user to fill in such details that are required on refund vouchers after leaving the shop.

As indicated above, subject to legislative requirements in a give territory, user (e.g., traveller) purchases can be recorded using a token when making a purchase and eligibility could be determined at a point exit from the territory. By moving the determination of eligibility away from the point of sale, the dependence on people who are less well trained can be reduced, and eligibility can then be performed by properly equipped trained customs or other staff or even by machine (e.g., using biometric testing).

Examples of possible tokens can include a passport number, a passport, a landing card, an identity card number, an identity card, a drivers licence number, a drivers licence, a payment card number, a payment card, a card refund operator card number, a card refund operator card, a visitor card number, a visitor card, a user defined identifier, a mobile phone, etc. As indicated, the token could be a visitor card or other visitor token that could be issued to the user, for example on entry to the territory, with or without checking of identity at this stage. The visitor token could, for example, be a chip card or a card with a magnetic stripe or a bar code that would have a unique number.

By presenting the token when making a purchase, a record of the purchase can be made associated with the token. A computer record can be made of an association between the token and a transaction identifier for a purchase transaction for one or more purchases. The token can then be used subsequently to retrieve the record of the transaction(s) on exit from the territory to validate the refund on later purchases, for example for one or more subsequent trips. In an example embodiment, a computer record of the transaction identifier could be stored without a token if no token is available, the transaction identifier effectively becoming a temporary token.

In the following a system and method of an example embodiment of a tax refund system for a territory is described with reference to FIG. 1 in which one or more TROs, for example multiple TROs, affiliate merchants, and then provide tax refunds to users through the user of a self-service kiosk 22 at an exit point from a territory.

A token can be allocated to a user at stage 102. This can be done before or at a point of entry to the territory or at a point of sale. Alternatively, it can be allocated following a purchase, for example at a kiosk 22 on exiting the territory in which the purchase is made and then be usable for subsequent trips, or at some intermediate time. In the latter case, the temporary token represented by a transaction identifier for the purchase can be used to form or to set up a token for the user. In one example the user can choose a token to be used. For example the user could specify, for example via a website, or at a point of sale or other terminal, or in response to being asked by a merchant, or at a kiosk 22, a particular token to be used (e.g., a token of one of the types referenced above). For example, a user can register his/her details and associate his/her details with one or more tokens by registering on a web site provided by a TRO. The TRO can then provide information to the user about refund opportunities and processes. Alternatively, or in addition, the user could be issued with a token (for example a visitor card as mentioned above). User details can then be recorded in an input station local to the point of issue, for example at the point of entry to the territory, at a point of sale, or a point of exit from the territory, or the issued token could be linked to user details pre-entered on the TRO website. A suitable input station can include, for example, a computer processor and memory, one or more input interfaces in the form of one or more of a keypad, a keyboard, a touch sensitive screen, a card reader, a machine readable identifier reader, a document scanner, a voice-activated input, and one or more output interfaces in the form of one or more of a display, a printer, a card writer, a speaker. The input station could also be provided with a finger print reading and/or camera technology for verifying biometric information held on a machine readable user identifier (e.g., an ID document such as a passport).

A token identifier (for example a number unique to the token along with details of the user (the traveller) can be provided 103 to and held at an acquiring host server system 20 where the identifier and the user details are recorded (stored). The host server system 20 can comprise one or more server computers, each comprising one or more processors and memory, located in a single place or in a distributed system. The efficiency of the system is enhanced where the identifier for the token and the details of the user are forwarded to the host server system and are recorded in real time. In the event that a transaction identifier has been stored without a separate token identifier, then the token identifier when issued can be associated with the transaction in the acquiring host server system 20, for example.

The user 12 can make purchases at 104, for example at a merchant, using the token if available. When presented with the normal shop receipt, the user 12 can be asked if a tax refund is required (or the user can ask for a tax refund). If a refund is desired, a second, simple transaction can be created by entering a receipt identifier (e.g. a receipt number), the value of the goods purchased, and the token identifier, if available. Thus, in this example embodiment, information including two or three items (receipt identifier, value of purchase, and token identifier if available) can then be electronically transmitted by a merchant system 14 to the acquiring server system 20. The merchant system 14 can comprise one or more computers, each comprising one or more processors and memory, located in a single place or in a distributed system. The functionality can be integrated into a point of sale (POS) terminal where purchase details are directly retrieved from an electronic cash register (ECR) and therefore there is no need to enter this information again. Alternatively, the information could be entered in a stand alone terminal such as a web based issuing application, a card payment terminal not linked to an ECR, other applications or software not linked to an ECR. These alternatives could require re-entry of the relevant purchase details to allow an approval system of a customs officer to verify the purchases made.

There may be only one TRO in a market. However, where there are multiple TROs in a market, there can be multiple acquiring system hosts 20. The relationship between a merchant and a TRO is that of merchant and acquirer (to use the credit/debit card example). Each TRO affiliates its own merchants and is responsible for the point of sale (POS) devices and integrated software that creates a tax refund transaction.

The transaction message can therefore be transmitted 105 to the TRO acquiring host system 20 where further processing can be performed. The transaction message format between the POS and the acquiring host can take any appropriate form as this can be proprietary. In one example the transaction message transmitted between the merchant system 14 and the acquiring host 20 contains the token identifier (e.g., a token number) if available, a receipt identifier (e.g. a receipt number), references to the goods purchased, a merchant identifier, a TRO identifier, a time and date stamp, and a security hash (which is used to prevent tampering). It may in addition contain information about a tour guide, promotional codes, or any other data that the TRO wishes to collect.

A separate acquiring host system 20 can be provided for each TRO, so that commercially sensitive information can be kept separate in that each TRO is only able to see transactions generated by its affiliated merchants. All tax refund transactions generated by affiliated merchants can be stored in the database of the acquiring host system 20. A transaction record as stored in memory of the acquiring host system can include, for example, a unique transaction identifier for the transaction, a token identifier (e.g., a token number) where available, a receipt identifier (e.g. a receipt number), references to the goods purchased, a merchant identifier and a time and date stamp. The acquiring host system 20 can allocate the unique transaction identifier (e.g., a unique transaction number) to the transaction in order that a unique number is available within the system to track that transaction during processing. The transaction identifier can be returned to the merchant system and can be printed on a purchase receipt given to a user, using clear text and/or a visible encoding such as a bar code or the like.

A message interface 24, for example a web-service based interface using an industry standard (e.g. SOAP, WCF, XML over IP), can provide an interface for messages to be formatted and/or routed. For example transaction messages can include one or more of the transaction identifier (e.g. a transaction number), the token identifier (e.g., a token number) if available, the receipt identifier (e.g. a receipt number), references to the goods purchased, the merchant identifier, the TRO identifier, the time and date stamp, and the security hash (which is used to prevent tampering). The message switch 24 may be a separate system, or combined with a custom approval system 26 according to a particular implementation.

In one example embodiment the message interface 24 could be implemented as a server system that comprises processing and storage capacity and is operable to act as a central repository for data to be accessed by the acquiring host system(s) and the customs approval system as well as providing for message formatting and forwarding. However, in another embodiment the data can be held in the TRO's host systems and can be accessed via the message switch by the customs approval system 26.

The customs approval system 26 provides an authorisation system for authorising refunds, and can be run by a customs authority, or on its behalf by a third party. The customs approval system 26 is capable of approving or rejecting tax refund transactions automatically based on rules set in the system by customs. The customs approval system 26 can also be accessed manually by a customs officer.

Validation systems including self-service validation stations (kiosks) 22 at the territory exit points can be connected to the TRO host system(s) 20, for example via a standardized web service or through the message interface 24. A validation station 22 can be configured to invite a user to present a personal identifier (e.g., an identity document such as a passport) to be read. A validation station 22 can be provided with one or more input interfaces in the form, for example, of one or more of a keypad, a keyboard, a touch sensitive screen, a card reader, a scanner, a voice-activated input and one or more output interfaces in the form, for example, of one or more of a display, a printer, a card writer, a speaker. The validation station 22 could also be provided with a finger print reading and/or camera technology for verifying biometric information held on a machine readable user identifier (e.g., an ID document such as a passport).

In one example the validation station 22 can be configured to determine the eligibility of a user for a tax refund by machine reading the personal identifier. In this example the validation station 22 reads the information from the personal identifier and determines eligibility by checking the information against an internal database that contains information about domestic/non-eligible users. In this case, the user can be deemed eligible if his/her nationality or status is not on the list (negative approval). Alternatively, or in addition, the validation station 22 can be operable to determine eligibility by checking the information against an internal database that contains information about non-domestic/eligible users. In this case, the user can be deemed eligible if his/her nationality or status is on the list (positive approval).

As mentioned above, the validation station 22 could also be provided with a fingerprint scanner and/or a camera and can be used to verify the identity of a user using biometric information held on the machine readable identifier (e.g., the identity documents such as a passport). A discussion about such biometric information is to be found, for example, at the following Internet link: http://www.highprogrammer.com/alan/numbers/mrp.html.

Where eligibility of a user is determined at a validation station 22, then the validation station 22 can be operable to prompt the user to present a token. In the event that the user presents a token, then the validation station 22 can be operable to send one or more validation request messages to the TRO host system(s) 20 a standardized web service and/or via the message interface 24. In response to receipt of the token, the TRO host system 20 will return all transactions that are suitable for export validation.

Where the user does not enter a token, for example if the token has been mislaid, the validation station can be operable to prompt the user to enter a transaction identifier that relates to a transaction effected with a token to retrieve the information for that token. The transaction identifier can be printed in human and/or machine readable form on a purchase receipt.

As another alternative, for example if the user had not already registered, then the user can be prompted to enter registration details, for example including a token to be used.

The validation station can also be operable to prompt the user to enter one or more transaction identifiers that relate to transactions effected without a token and to associate the transactions with the user. The transaction identifier can be printed in human and/or machine readable form on a purchase receipt.

The order of operation of the validation station 22 could vary from that indicated above according to implementation.

Further details of the operation of the validation station will be described later.

In another example, the validation station 22 can be configured to prompt a user to enter the user identifier and the token and then to pass a validation request message to a custom approval system to request approval based on both the eligibility of the user and the transactions recorded in association with the transactions. In this other example, the validation station 22 can transmit a validation request message that includes the information from the identifier and the token identifier, and the customs approval system can determine eligibility and whether to validate the transactions.

As will be described in the following, the validation station can also be operable to prompt the user to enter missing or further personal information or transaction details that are not already held centrally (for example to complete a registration process and/or to obtain a token, or to enter purchase transactions for where no token was presented and/or available at the time the purchase transaction was performed). Computer records associated with information entered at the validation station can then be updated or recorded centrally in the acquiring host systems 20.

The customs approval system 26 can be operable to respond to a validation request message to retrieve all the transactions for the user (for example all transactions already associated with the token and/or transactions entered at the validation terminal) from its own database and/or from the acquiring host systems 20, and can apply rules set to determine approval or rejection.

In one example, the customs approval system 26 could be set to either automatically approve one or more of the transactions based on rules that have been set, (“green channel”) or automatically to reject a transaction (“red channel”), again based on rules set within the customs approval system 26.

When the customs approval system 26 has made a decision about a transaction (approve/reject), an authorization message (validation request response message) is automatically routed through the message interface 24 back to the appropriate acquiring host system 20. Such a response could be in the form of a web service response and can hold the electronically approved transactions (including an electronic customs stamp). The acquiring host system 20 updates an existing tax refund transaction record for the transaction with the authorization message (approve, reject, change).

In an example embodiment the customs approval host does not act as the payment authorization host, but rather the TRO's acquiring host system 20 is the system of record.

Each acquiring host system 20 formats and transmits a refund message to the validation station indicating which transactions have been approved for “green channel” automatic payment. A TRO that issued a token can be given first position on the validation station, and that TRO's transactions are displayed.

If one or more of the retrieved transactions have approved codes, the user could be given “green channel” service for the approved transactions and could be asked how a refund is to be paid. If any of the transactions are not approved, the user is given “red channel” service for at least those transactions (possible for all transactions) and is asked to present himself to a customs officer for further processing.

If the choice of refund is to a payment card (e.g., a credit card), the refund can be made automatically to the registered payment card. If no payment card is registered, the validation station can optionally prompt the user to swipe a card to which the refund should be made.

If the user requests a cash equivalent refund and the user has used a TRO issued token that can store a cash amount, then the refund amount can be credited to the token. Alternatively, or in addition, if the user requests a cash equivalent refund and the user has not used a TRO-issued token, a stored-value card or cash could be issued from the validation station 22, subject to the kiosk being provided with a cash dispensing capability.

In the event that red channel processing is indicated, then the validation station prompts the user to presents the token and the identifier to a customs officer, who can then use the token to begin processing. A customs official can be provided with an approval station that is linked to or forms part of the customs approval system 26. However, in other examples, the approval stations can be separate from and/or remote form the customs approval system and can communicate therewith, for example via the message switch.

In response to input of a token identifier (e.g., where the token is a magnetic stripe card, by swiping the card), the approval station can be configured to use the token identifier to transmit an information retrieval message to the customs approval system 26, that can then retrieve a list of approved and rejected transactions associated with the token.

The customs officer can then approve or reject each transaction, or change (reduce) the value amount. The customs officer can enter the result of his/her decisions using input device(s) of the approval station 28. The result of his/her decisions is communicated by the customs approval system 26 through the message switch 24 to the appropriate acquiring host system 20. The acquiring host system 20 now contains tax refund transactions with approval codes (approved, rejected, changed value).

In some implementations, the user could then return to the validation station 22, present his/her token once more and be prompted for the manner of the refund as discussed above.

The customs authorisation system 26 can be configured to operate in one or both of two modes of operation. In one mode of operation, information for transactions is stored on the respective acquiring host systems 20. In the first mode of operation, the customs approval system 26 is operable to retrieve transaction information from the respective acquiring host system 20 for validating refunds. The result of the authorisations is communicated back through the message switch 24 to the appropriate acquiring host system 20. The acquiring host system 20 now contains tax refund transactions with approval codes (approved, rejected, changed value). In the second mode of operation, the customs approval system retains a copy of each transaction within its own database, associated not only with the relevant token identifier, but also with an acquiring host system identifier. In this case the customs approval system 26 also passes the transaction and approval code back to the acquiring host system 20 concerned. The difference between the two modes is that in the second mode, the CAS retains a copy of all data from all acquiring host systems 20.

Secure transmission, messages and protocols can be used for communicating information using existing software, equipment, and processes for handling secure financial transactions as known for electronic payments. A standards-based message format can thus be used for transmitting refund transactions. The use of standard message format can allow for multiple TRO providers, while ensuring that customs and tax authorities only have to deal with a single system for approvals.

By recording transactions on the acquiring host system 20 and/or on a customs approval system 26 using at least a transaction identifier and a value of purchase, and then associating user detail records linked to a token identifier in the acquiring host system, a customs approval system 26 can be operable to retrieve refund transactions from the acquiring host system 20 of a TRO based on the presentation of a token, to indicate a “yes/no” response to a request for permission to refund, and to transmit that result to the acquiring host system 20.

In the illustrated example communication between the acquiring host system(s) 20 and the customs approval system 26 can be effected via a message interface 24. The message interface 24 can provide a dedicated network between the customs approval system 26 and the acquiring host systems 20 for one or more TROs. The message interface can be implemented using web services or other online or offline connection arrangements.

In an example embodiment, automated validation stations (kiosks) 22 can be provided that allow automatic pre-screening of refund transactions to generate a “red channel/green channel” response without human intervention. The automatic pre-screening process could be effected using, for example a validation station 22 (e.g., a kiosk) at an exit point form the territory.

The validation station 22, or an approval system (e.g. the customs approval system 26) in communication with the validation station 22, could be provided with rules defining a “red channel” requirement, for example for high-value purchases and/or for purchases of a particular type. The “red channel” behaviour could be to require a user to present a token, shopping receipt, passport, and the goods purchased to a Customs Officer at a customs station 16 for approval.

The validation station 22, or the approval system 26 in communication with the validation station, could be provided with rules defining a “green channel” situation providing automatic approval according to certain criteria such as: country of origin of the traveller, item value, transaction value, value of all transactions, quantity of goods, merchant, etc., and logical combination of such criteria. Also white and black lists for countries or origin, retailers, travellers and so on can be used.

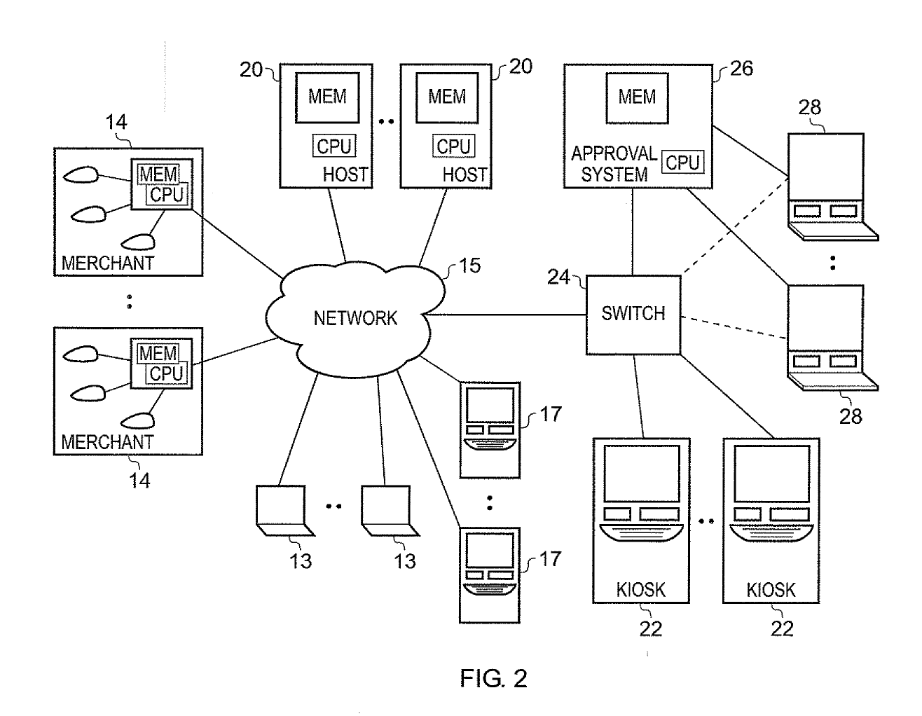

FIG. 2 is a schematic system diagram giving an overview of an example overall system configuration of an example embodiment.

FIG. 2 illustrates various systems connected via a network 15, for example the Internet.

FIG. 2 illustrates a plurality of user computers 13 (e.g. a desktop, laptop, personal data assistant, mobile telephone, etc) connected to the network 15. A user computer 13 can be used by a user (e.g., a traveller) to access a website to register a token. The website can be provided by one of a plurality of TROs, a tourist or travel organisation or authority, by way of example only.

FIG. 2 illustrates a plurality of input stations 17 connected to the network 15. An input station 17 can be provided, for example, at a point of entry (e.g. an airport immigration area), a tourist office, a railway station, a retailer etc. An input station 17 can be provided with one or more input interfaces in the form, for example, of one or more of a keypad, a keyboard, a touch sensitive screen, a passport or other ID document reader, a card reader, a scanner, a voice-activated input and one or more output interfaces in the form, for example, of one or more of a display, a printer, a card writer and/or dispenser, a speaker. In an example embodiment the input station can be operable to issue a token, for example a card with a unique identifier. The unique identifier can be carried by the card (for example a plastic or paper card) and can, for example be a unique card number, the passport number, a payment card number or some other identifier for the user. However, it is to be noted that in other example embodiments a physical token need not be issued, but the token may be another pre-existing identifier such as a passport, an ID card, a credit card or the like.

FIG. 2 illustrates a plurality of merchant systems 14 connected to the network 15. Each merchant system 14 can involve one or more computer systems, each comprising one or more processors and memory, and one or more point of sale devices, that can include one or more input interfaces in the form, for example, of one or more of a keypad, a keyboard, a touch sensitive screen, a card reader, a scanner, a voice-activated input and one or more output interfaces in the form, for example, of one or more of a display, a printer, a card writer, a speaker.

FIG. 2 illustrates a plurality of TRO acquiring host systems 20 connected to the network 15. Each acquiring host system can involve one or more computer systems, each comprising one or more processors and memory.

FIG. 2 illustrates a message switch 24 connected to the network 15. In this example the message switch 24 acts as a communications interface between the acquiring host systems 20, validation stations and a customs approval system 26.

FIG. 2 illustrates a plurality of validation stations 22 connected to the network 15. A validation station 22 can be located at a point of exit (e.g. an airport departure area). A validation station 22 can be provided with one or more input interfaces in the form, for example, of one or more of a keypad, a keyboard, a touch sensitive screen, a passport or other ID document reader, a card reader, a scanner, a voice-activated input and one or more output interfaces in the form, for example, of one or more of a display, a printer, a card writer and/or dispenser, a speaker. The validation station could also be provided with one or more devices for inputting user biometric information, such as a finger print scanner or a camera.

The familiarity of users with automated teller machines and the like means that validation stations in the form of automated self-service kiosks at the exit points are acceptable to users.

As described above, in one example, the validation station 22 can be provided with a reader for automatically reading machine readable identifiers (e.g. machine readable identification documents such machine readable passports and can thereby enable automatic verification of the identity and eligibility of the user for a refund. The validation station 22 can prompt the user to present the token identifier. As also indicated above, the token can be in the form of a magnetic stripe card, a chip card, a bar code, a passport, ID card, a number that has to be entered at a key pad, etc.

If a token is provided by the user, the validation station 22 can then determine eligibility for a refund based on information held in a customs approval system or a TRO acquiring host system defining one or more purchases associated with the token identifier, in order to determine whether to validate a refund associated with the one or more purchases. Optionally the validation station 22 could receive biometric information and cross check this against information held on the machine readable identifier to verify the identity of a user.

The validation station 22 can be operable to provide the user with other options than the present of a token to identify the user and/or to associate purchases with the user, for example by prompting the user to input a transaction identifier.

In one example the validation station can respond to input of the token identifier to transmit a request to the server for information defining one or more purchases associated with the identifier, to compare information received from the server defining one or more purchases associated with the identifier to pre-defined rules to determine whether to validate a refund and to cause the output interface to indicate to the user whether the refund has been validated automatically (i.e. whether the validation is effected automatically). In one example, the pre-defined validation rules are held in a customs approval system and would be received from the customs approval system with an electronic customs stamp attached. Where the refund is validated, the validation station can to transmit to the server confirmation that validation has been effected for the refund to be effected.

In example embodiments the validation stations can allow the user to modify his transactions. Means exclude transactions or items out of transactions or decrease quantity and amount of certain purchases, prior to requesting approval.

In another example, the validation station can respond to input of the token identifier to transmit a request to the server to determine whether to validate a refund and to be respond to a response from the server indicative of whether a refund for the one or more purchases has been validated to cause the output interface to indicate to the user whether the refund has been validated (i.e. whether the validation is effected automatically).

Alternatively, the user can be prompted to report to a manual validation check by a customs officer.

The validation station can also be operative to prompt the user to identify the refund should be made (for example to a credit card or with cash). If the user selects credit card, the transaction can automatically be refunded. If the user selects cash, then the user can be issued a fully active debit card with the refund amount, or be prompted to go to a place airside to receive the cash.

If a “red channel” response is the result, the user can be prompted to indicate how a refund is to be made if approved, and the user can then be directed to a Customs desk for further checking.

At the customs desk, a customs office can use an approval station to retrieve the information from the server system using the token identifier and/or a transaction identifier.

An approval station can be provided with one or more input interfaces in the form, for example, of one or more of a keypad, a keyboard, a touch sensitive screen, a card reader, a scanner, a voice-activated input and with one or more output interfaces in the form, for example, of one or more of a display, a printer, a card writer, a speaker.

Using the token identifier or a transaction identifier, the customs officer can call up the transaction information from the server system, inspect the documents and goods, and decide whether to approve or reject the refund.

If the refund is approved, and the user had requested a credit card refund, the credit card transfer could then be effected automatically in response to the customs officer approving the refund using the approval station. Alternatively, a debit card could be generated by the approval station, or by the validation station.

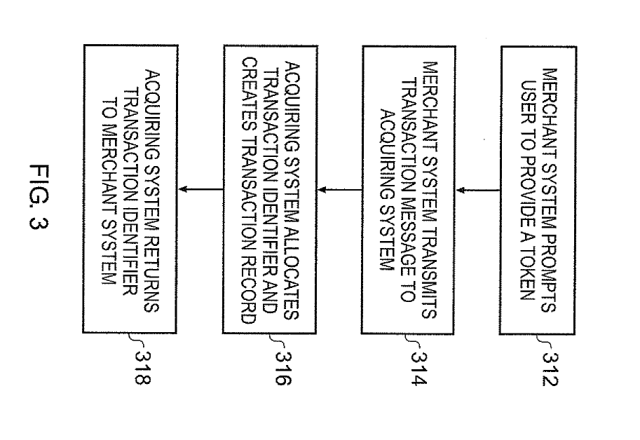

FIGS. 3-7 provide a flow diagram giving an overview of the operation of a system as illustrated in FIGS. 2 and 3.

FIG. 3 illustrates processes that can be performed at a point of sale where a user makes a purchase.

At 312, the user is invited to provide a token (for example the user can present a token or can be issued with a token).

At 314, the merchant system 14 transmits a transaction message to an acquiring server system 20 of a TRO that has provided the merchant with the POS devices and/or software. The transaction message can include a receipt identifier (e.g. a receipt number), the value of the goods purchased, and the token identifier, if provided. Further information can also be included in the message, for example details of the goods purchased.

At 316, the acquiring server system 20 allocates a transaction identifier (e.g. a transaction number or string) the transaction and creates a transaction record including the transaction identifier, the receipt identifier, the value of purchase, and the token identifier, if available). The transaction record identifies whether a token identifier was received with the transaction message indicating that the user was identified by the merchant, for example by setting a “Registered” flag (e.g. a bit) to indicate this. Further information can also be included in the transaction record, for example details of the goods purchased.

In other words, an example transaction record entry held at the acquiring host system can include the following fields, some or all of which may be populated in step 316:

Transaction identifier

Receipt identifier

Value of purchase

Token identifier;

Registered flag;

Details of Goods;

Details of traveller;

A payment target.

At 318, the acquiring server system 20 returns a transaction response message that includes the transaction identifier that can be printed on the purchase receipt printed by the merchant system 14.

Steps 310-318 can be effected in real time in parallel with the credit card authorisation processing so that no additional delay is required a the point of sale.

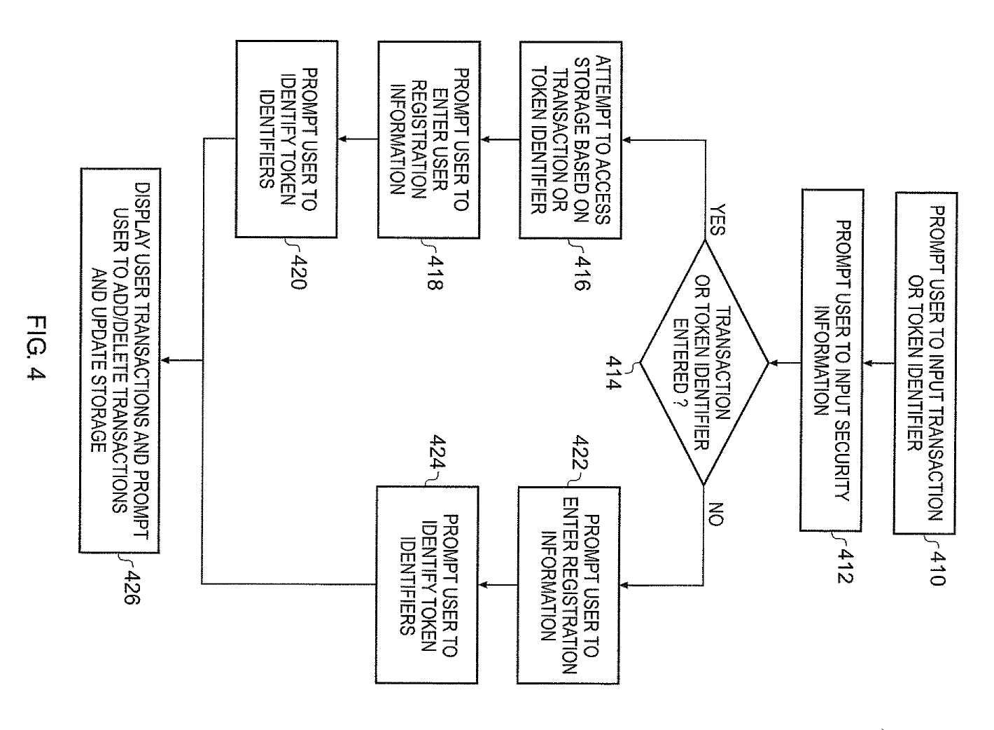

FIG. 4 represents a registration process for a user. Registration can take place prior to making a first purchase, for example using a website or a dedicated terminal before travelling to a territory, on entry to a territory, at a hotel or another place in the territory, or following a purchase at, for example a hotel or another place in the territory or at a point of exit from the territory. For convenience, reference is made below to performing registration at an input station. As mentioned earlier, an input station can include, for example, a computer processor and memory, one or more input interfaces in the form of one or more of a keypad, a keyboard, a touch sensitive screen, a card reader, a machine readable identifier reader, a document scanner, a voice-activated input, and one or more output interfaces in the form of one or more of a display, a printer, a card writer, a speaker. The input station could also be provided with a finger print reading and/or camera technology for verifying biometric information held on a machine readable user identifier (e.g., an ID document such as a passport).

The user can be prompted at 410 by the input station to enter a transaction identifier for a purchase transaction made by the user or a token identifier for a token issued to the user transaction.

Optionally, at 412 the input station can be configured to prompt the user to enter security information (e.g., password or other key or information known only to the user) to access any data associated with a purchase or with a user. The security information can be associated with the transaction record on at the acquiring server system in accordance with conventional security standards.

If the input station identifies at 414 that a transaction or token identifier is entered, then at 416 the input station uses the input transaction of token identifier to attempt to access any information associated therewith from an acquiring server system 20. For example, it may be that a token identifier is already associated with a transaction identifier on the acquiring server system 20.

At 418 the input station can prompt the user to add any information needed to complete user registration and/or to enable verification of the eligibility status of the user for tax free refunds. If the information already held for a user associated with a token is determined to be insufficient to enable eligibility, then optionally (according to local requirements) a message can be sent to the acquiring host system to reset any Registered flags for transactions having the input token identifier as registration was not then complete at the time of purchase.

At 420, the user can be invited to identify one or more token identifiers for a token to be associated with the user. The token identifier(s) can then associated with the personal information for the user and/or with any transaction identified by an input transaction identifier.

If, at 412, the input station identifies that no transaction or token identifier is entered, then at 422, the input station prompts the user to enter registration information, which registration information can include information required for determining eligibility for tax refund and/or addition information. The information for a personal record can include data such as a user's name, residence address, nationality, passport number, etc.

At step 424, the user can specify one or more token identifiers to identify one or more tokens, for which example tokens have been identified above. Alternatively, the input station could be configured to issue a physical token identified by a token identifier.

At 426, the input station can be operable to display to a user any transactions that have been retrieved as being associated with the user and to prompt the user to add transaction identifiers for any transactions that are not indicated on the list of transactions. If the user then input any further transaction identifiers, the input station can be operable to signal the acquirer server system 20 to add the input token identifier to the transaction record for that transaction as held on the acquirer server system 20. In this case, the token identifier would be added to the transaction records for the transactions, but the pre-registered flag mentioned above would not be set as the transactions message from the merchant would not have included the token identifier and therefore it is to be assumed that the merchant had not identified the user's identity.

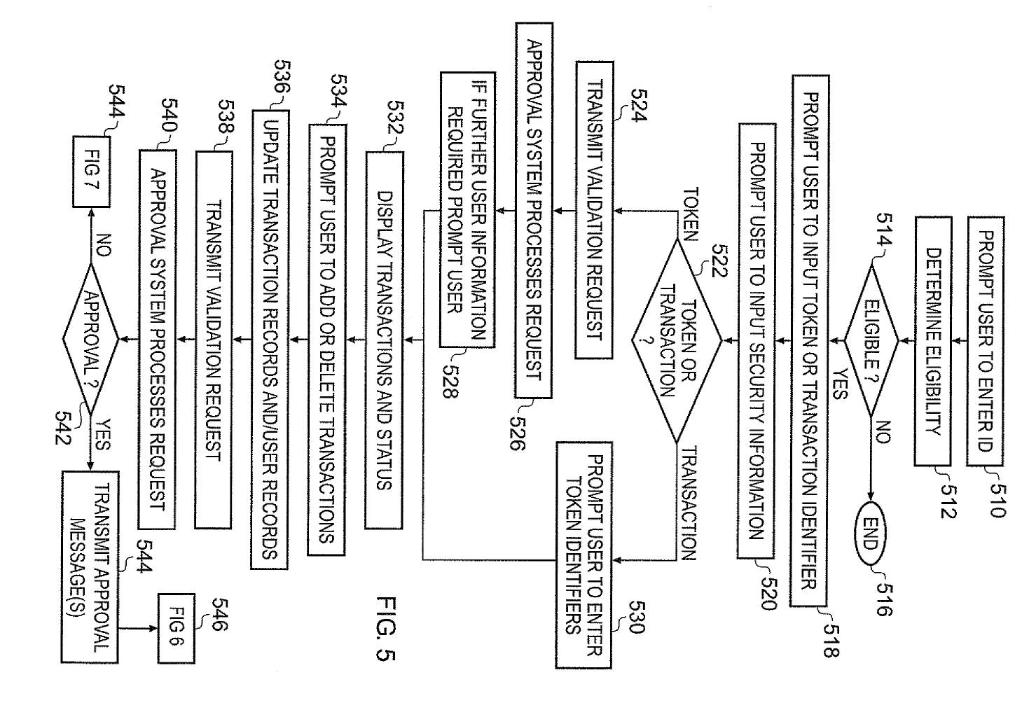

FIG. 5 illustrates a process performed on leaving a territory.

Optionally, the user could be prompted by the validation station (an automated or self-service kiosk) at a point of exit from the territory to present a machine readable ID (e.g., a passport) to an ID reader of the validation station at 510.

In this example, at 512, the validation station is configured to determine the eligibility of a refund for the user based on stored information and on the identity of user derived from the machine readable ID. Optionally, the validation station could also verify the identity of the user by using biometric data held on the machine readable ID (e.g. a finger print or an iris pattern).

At 514, if the user is not eligible, then the validation station provides the user with an appropriate message and the process ends at 516. For example, the user could be referred to a customs desk for manual processing.

The above steps are optional in that a user may already have had his or her identity verified at a time or purchase. Indeed, in some territories, this can be a requirement.

Accordingly, according to a particular implementation, if the validation station determines that the user is eligible, or if steps 510 to 514 are omitted, then at 518 the validation station can be configured to prompt the user to enter a transaction identifier for a purchase transaction made by the user or a token identifier for a token issued to the user transaction. For example a purchase receipt or a token can be presented by a user to be read by the validation station (e.g., using a bar code scanner for a bar code on a receipt or a card reader if the token is a card), or the appropriate identifiers can be input manually using keys or the like.

At 520, the validation station can optionally prompt the user at 416 to enter security information (e.g., a PIN, password or other key or information known only to the user) to access any data associated with a purchase or with a user. The security information can be associated with the transaction record on at the acquiring server system in accordance with conventional security standards.

At 522, if the user presented a token, then the validation station can be operable to transmit at 524 a validation request to the customs approval system including a token identifier.

At 526, the approval system can check the transactions (available in the approval system and/or from an acquiring host system as appropriate) using an entered token or transaction identifier to retrieve relevant transactions and can also check the user registration data.

At 528, if the validation station determines that further information is needed to complete user registration and/or to enable verification of the eligibility status of the user for tax free refunds, then the validation station can be configured to prompt the user to enter that information. If the information already held for a user associated with a token is determined to be insufficient to enable eligibility, then optionally (according to local requirements) a message can be sent to the acquiring host system to reset any Registered flags for transactions having the input token identifier as registration was not then complete at the time of purchase.

If it is determined at 522 that the user entered a transaction identifier, then at 530 the user can be invited to identify one or more token identifiers for one or more tokens to be associated with the user (e.g. by presenting the token to be read by the validation station). The token identifier(s) for token(s) can then be associated with the personal information for the user and/or with any transaction identified by an input transaction identifier held on an acquiring server system.

At 532, the input station can be operable to display to a user any transactions that have been retrieved as being associated with the user. The display of the transactions can be made with an indication of the qualifying status for respective purchases (for example with a green or red status as described elsewhere herein).

At 534 the validation station can be operable to prompt the user to add transaction identifiers for any transactions that are not indicated on the list of transactions and/or to remove purchases that are shown on the list but are not to be exported.

If at 536, the user inputs any further transaction identifiers, (e.g., by presenting purchase receipts for scanning by the validation station), the validation station can be operable to access the acquirer server system 20 and to link the transaction record for that transaction as held on the acquirer server system 20 to the user. This means that a user that made a purchase without having the token available can then add that purchase to the purchases to be considered for a refund. In most instances these transactions will have records at the acquirer server system 20, but the token identifier will not be included in the transaction record. In such cases, the transaction records can be updated by adding a token identifier for the user to the transaction record. Optionally, it can be possible to add a new transaction not previously recorded on the acquirer server system 20 (for example in the event that there had been a network fault a the time the purchase was made), in which case a complete record for the transaction can be created using such information as is available on a purchase receipt. In this case, the token identifier can be added to appropriate transaction records for the transactions, but the pre-registered flag mentioned above would not be set as the transactions message from the merchant would not have included the token identifier and therefore it is to be assumed that the merchant had not identified the user's identity.

In the event that further user details are entered at 524 and/or further transactions are added at 534, then at 538, the validation station can be operable to transmit a further validation request to the customs approval system including a token identifier.

At 540, the approval system can check the transactions (available in the approval system and/or from an acquiring host system as appropriate) using an entered token or transaction identifier to retrieve relevant transactions and can also check the user registration data.

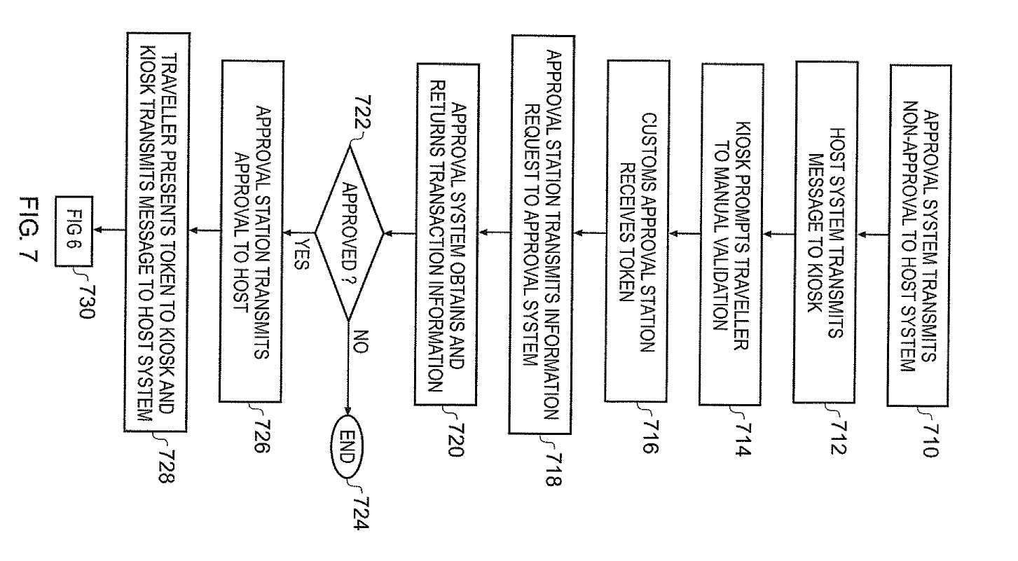

If, at 542 approval is not given automatically, then the further processing is described with reference to FIG. 7. The conditions that can lead to automatic approval not being given can depend on predefined rules that can vary according to various legal and regulatory requirements as will be discussed later

Alternatively, if approval is given automatically, then the approval system can transmit at 544 an approval message to the respective acquiring host system for each approved transaction. The conditions that will apply for automatic approval can depend on predefined rules that can vary according to various legal and regulatory requirements as will be discussed later.

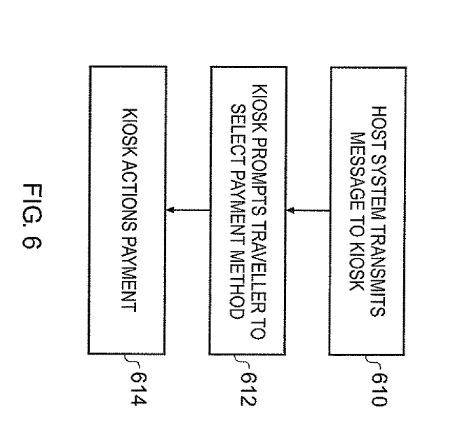

The process then continues at 546 in FIG. 6

Turning to FIG. 6, for each acquiring host system that received an approval message from the approval system, the acquiring host system can transmit an appropriate approval message at 610 to the kiosk.

At 612, the kiosk can prompt the user to select a payment method.

At 614, the kiosk can action the payment, for example by inviting the user to enter a payment to which a refund is to be credited, or by dispensing a card having a cash amount thereon.

Turning to FIG. 7, where approval is not given automatically at 524, then the approval system can transmit at 710 a non-approval message to the respective acquiring host system for each approved transaction.

At 712, an acquiring host system receiving such a non-approval message transmits an appropriate non-approval message to the kiosk.

At 714, if the kiosk receives a non-approval message, it can prompt the user to report to customs for a manual validation check.

At 716, a customs officer can receive the token from the user or can invite the user to enter the token at a customs approval station.

At 718, the approval station transmits an information request to the approval system including a token identifier.

At 720, the approval system obtains transaction information (available in the approval system and/or from an acquiring host system as appropriate) using the token identifier to identify relevant transactions and returns the transaction information.

If, at 722, the customs officer approves a transaction then the process terminates at 724 with the user (traveller) being told that the transaction is not approved by the customs officer, and by a message being returned from the approval station to the approval system and the acquiring host concerned that approval for a refund in respect of a given transaction is not given.

Alternatively, if at 722 approval is given for a refund, then at 726 the approval station transmits an appropriate message via the approval system to the relevant acquiring host system that approval for given transactions is given.

At 728 the user can present the token to the kiosk and a refund message can be sent to the acquiring host for transactions associated with the token.

As indicated at 730, the further processing to effect the refund can proceed as indicated in FIG. 6 is steps 610-614.

As mentioned above with reference to step 542, the conditions that can lead to automatic approval being or not being given can depend on predefined rules that can vary according to various legal and regulatory requirements.

For example, a typical requirement is that the purchaser of the goods is an eligible person who also exports the goods. Accordingly, in the situation that eligibility is not verified a the time of purchase, for example as a result of the user not having registered at that time, an embodiment of the invention enables this to be identified from the transaction record held in the system. In such a case, at step 542, the system can be operable to indicate red channel processing (i.e. non-automatic processing for the user). In the present example the verification of eligibility and/or registration at the time of a transaction can be identified from the status of the “Registered” flag in a transaction record. As also explained above, optionally according to local requirements, the “Registered” flag for a transaction can be reset if, for example, it is determined subsequently to the time of purchase that registration is incomplete.

Although in the present example a “Registered” flag is used as a means of tracking verification of eligibility, it will be appreciated that in other examples the tracking of eligibility can be achieved by date stamping records and comparing timings of recordal of eligibility verses the time of purchase transactions.

Other factors can affect the availability of automatic approval such as the value of goods purchased, the types of transactions, a pattern of transactions, the nationality of a user, etc. Also, non-automatic processing can be required on a statistical basis as a part of a sampling process.

Accordingly non-automatic processing (red channel processing) can be determined at step 542 when locally determined requirements for automatic processing are determined not to have been met and/or a statistical sample processing is required. Accordingly, an example system provides for increased flexibility of operation while still providing secure and verifiable operation.

In the example system described above, the transaction records are held in the acquiring host system(s) 20 and these are accessed by the customs approval system and/or the terminals and kiosks. However, in another example the transaction records could be held alternatively or in addition in the message switch, where this is configured as a central server system.

Also, although in the described example an automated kiosk or validation station 22 is shown in addition to a customs station 16, the customs station 16 could be provided with the functionality of the validation station 22 and/or could replace the separate validation station 22. In the cases that the a customs station 16 forms an example of the validation station 22, the entry of the user information can be performed by the user or by a customs official as appropriate.

A refund system provides for detections of eligibility of a user for a refund and uses a token to identify purchases and to retrieve the information in respect of those purchases for processing a refund in respect of those purchases.

By providing an integrated system with information available from a server system, in combination with the use of a token and/or a transaction identifier, purchases can be associated with a user and eligibility can be determined at a point of exit following the purchase transactions.

In an example embodiment identity and eligibility verification can be effected away from a shop. In an example embodiment this is done at the exit point. Additionally this can be done at an entry point. An embodiment enables this to be achieved through the use of the integrated network approach and the use of the transaction records having respective transaction identifiers for the transactions and optionally token identifiers for the user.

An embodiment may be embodied in a computer program product for operating one or more processors. The computer program product may be in the form of a computer program on a carrier medium. The carrier medium could be a storage medium such as a solid state, magnetic, optical, magneto-optical or other storage medium. The carrier medium could be a transmission medium such as broadcast, telephonic, computer network, wired, wireless, electrical, electromagnetic optical or any other transmission medium.

Although the embodiments described above have been described in detail, numerous variations and modifications will become apparent to those skilled in the art once the above disclosure is fully appreciated. It is intended that the following claims be interpreted to include all such variations and modifications and their equivalents.

1. Apparatus comprising a validation system, the validation system comprising:
validation system input means operable to receive an identifier for at least one of a user or a purchase transaction;
validation system processing means operable to prompt the user to input information for obtaining a tax refund associated with one or more purchase transactions;
the validation system processing means being further operable to cause information relating to users and purchase transactions and stored in a storage system to be updated based on information input by the user;
the validation system processing means being further operable to transmit a validation request message that identifies the user to validate a tax refund for the one or more purchases, eligibility being derived from user related information;
the validation system processing means being further operable to receive a response message from the approval system and to indicate to the user via validation system output means whether a refund associated with the one or more purchases has been validated.

2. The apparatus of claim 1, wherein the validation system processing means is operable to determine the identity of the user by comparing information input by the user at the validation system to stored information.

3. The apparatus of claim 1, wherein the validation system processing means is operable to prompt the user to input user information for completing user details required for obtaining a tax refund associated with one or more purchase transactions, the validation system being operable to cause information relating to the user and stored in a storage system to be updated based on the information input by the user.

4. The apparatus of claim 1, wherein the validation system processing means is operable to prompt the user to input purchase transaction information including a transaction identifier associated with one or more purchase transactions, the validation system being operable to cause a transaction record identified by the transaction identifier to be created or updated in the storage system with information relating to at least one of the purchase transactions and the user identity based on the information input by the user.

5. The apparatus of claim 4, wherein the transaction record identifies whether a user was a registered user at a time of creation of the transaction record.

6. The apparatus of claim 2, wherein the validation system is operable to prompt the user to enter security information to access data associated with a purchase transaction or the user.

7. The apparatus of claim 1, wherein the validation system processing means is operable to indicate to the user via the validation system output means purchase transactions retrieved for the user from the storage means.

8. The apparatus of claim 7, wherein the validation system processing means is operable to prompt the user to confirm that a refund is claimed for all of the purchase transactions or of a sub-set of the purchase transactions indicated to the user.

9. The apparatus of claim 1, wherein the validation system processing means is operable to prompt the user to enter any further purchase transactions to be considered for a refund.

10. The apparatus of claim 1, wherein the validation system processing means is operable to indicate to the user via the validation system output means the status of all purchase transactions retrieved for the user from the storage means.

11. The apparatus of claim 1, wherein the system input means is configured to read a machine readable user identifier for input of a user identifier.

12. The apparatus of claim 1, wherein the system input means is configured to read a machine readable transaction identifier from a purchase receipt for input of a transaction identifier.

13. The apparatus of claim 1 wherein the validation system comprises an automated kiosk.

14. The apparatus of claim 1 wherein the validation system fauns part of a customs approval station.

15. The apparatus of claim 1, wherein:
the validation system input means further comprises one or more of a keypad, a keyboard, a touch sensitive screen, a card reader, a reader for a machine readable identifier, a scanner, a voice-activated input, a camera, biometric information capture apparatus; and
the validation system output interface comprises one or more of a display, a printer, a card writer, a speaker.

16. The apparatus of claim 1, further comprising an approval system connected to the validation system via a network, the approval system comprising:
approval system input means configured to receive at least one of a user identifier or a transaction identifier;
approval system processing means configured to obtain information from an approval system that holds or has access to transaction information identifying one or more purchases associated with the user identifier or a transaction identifier;
an output interface configured to present to an official details of the one or more purchases and/or of the user associated with the identifier.

17. The apparatus of claim 1, further comprising the storage system holding information relating to users and purchase transactions, the storage system being connected to the validation system via a network.

18. The apparatus of claim 1 comprising an operator host system, the operator host system comprising:
the storage system for storing transaction information identifying one or more purchases in association with a token and a merchant identifier; and
processing means responsive to transaction information that identifies one or more purchases associated with a token from a merchant system to store the transaction information identifying one or more purchases in association with the token and the merchant identifier, the processing means being further operable to transmit the transaction information identifying with one or more purchases associated with the token to an approval system.

19. The apparatus comprising a merchant system, the merchant system having:
merchant system input means configured to receive a token identifying a user and/or details of one or more purchases,
merchant system processing means operable to transmit a transaction message to an operator host system, the transaction message defining one or more purchases associated with a token and a merchant identifier.

20. The apparatus of claim 1, wherein the apparatus operates real-time messaging.

21. The apparatus of claim 1, wherein the user identifier is one of a passport number, a passport, an identity card number, an identity card, a landing card, a drivers licence number, a drivers licence, a payment card number, a payment card, a card refund operator card number, a card refund operator card, a visitor card number, a visitor card, a user defined identifier, a mobile phone number, an RFID chip-based unique identifier; an OCR track of an identity document.

22. The apparatus of claim 1, wherein a purchase transaction identifier is a unique system generated identifier identifying a purchase transaction.

23. A computer implemented method of processing a refund at a validation system, the method comprising:
validation system input means receiving an identifier for at least one of a user or a purchase transaction;
validation system processing means prompting the user to input information for obtaining a tax refund associated with one or more purchase transactions;
validation system processing means causing information relating to users and purchase transactions and stored in a storage system to be updated based on information input by the user;
the validation system processing means transmitting a validation request message that identifies the user to validate a tax refund for the one or more purchases, eligibility being derived from user related information;
the validation system processing means receiving a response message from the approval system and to indicate to the user via a validation system output means whether a refund associated with the one or more purchases has been validated.
